(19) United States
(12) Patent Application Publication
(10) Pub. No.: US 2026/0258951 A1
(43) Pub. Date: Sep. 3, 2026

(54) COMBUSTION DEVICE AND GAS TURBINE SYSTEM

(71) Applicant: IHI Corporation, Tokyo (JP)

(72) Inventor: Shintaro ITO, Tokyo (JP)

(73) Assignee: IHI Corporation, Tokyo (JP)

(21) Appl. No.: 19/659,261

(22) Filed: Apr. 27, 2026

Related U.S. Application Data
(63) Continuation of application No. PCT/JP2024/038153, filed on Oct. 25, 2024.

(30) Foreign Application Priority Data
Nov. 22, 2023 (JP) 2023-198331

(51) Int. Cl. F23R 3/28; F02C 7/22; F23R 3/10

(52) U.S. Cl. CPC F23R 3/28; F02C 7/22; F23R 3/10

(57) ABSTRACT

A combustion device includes: a liner in which a combustion chamber is formed inside a side wall portion; a burner that injects fuel into the combustion chamber; an air introduction portion that introduces air into the combustion chamber; a separation wall portion provided on a radially outer side of the liner with respect to the side wall portion and forming an inner flow path communicating with the air introduction portion between the separation wall portion and the side wall portion; an outer wall portion provided on a radially outer side of the liner with respect to the separation wall portion; a plurality of communication holes formed in the separation wall portion in such a manner as to be separated from each other in a central axis direction of the liner; and a partition wall partitioning the inner flow path in the central axis direction of the liner.

### CROSS REFERENCE TO RELATED APPLICATIONS

This application is a continuation application of International Application No. PCT/JP2024/038153, filed on October 25, 2024, which claims priority to Japanese Patent Application No. 2023-198331, filed on November 22, 2023, the entire contents of which are incorporated by reference herein.

### BACKGROUND ART

### TECHNICAL FIELD

The present disclosure relates to a combustion device and a gas turbine system. The present application claims the benefit of priority based on Japanese Patent Application No. 2023-198331 filed on November 22, 2023, the content of which is incorporated herein.

### Related Art

Gas turbine systems, with which power is obtained by combusting fuel in a combustor, are used. For example, Patent Literature 1 discloses a gas turbine system using a low-calorie fuel instead of fossil fuel. According to the gas turbine system, a primary combustion zone in which rich combustion is performed and a secondary combustion zone in which lean combustion is performed are provided in a liner.

### Citation List

### Patent Literature

Patent Literature 1: Japanese Patent No. 5591408

### SUMMARY

### Technical Problem

In the gas turbine system described above, air supplied from a compressor to an outer passage cools the liner. In addition, a part of the air that has cooled the liner is supplied to a burner. In such a gas turbine system, when the flow rate of the air supplied to the burner decreases, harmful components such as NOx contained in the combustion gas may increase.

The object of the present disclosure is to provide a combustion device and a gas turbine system capable of suppressing an increase in harmful components in combustion gases.

### Solution to Problem

In order to solve the above problem, a combustion device according to the present disclosure includes:

a liner in which a combustion chamber is formed inside a side wall portion;

a burner that injects fuel into the combustion chamber, the burner provided to the liner;

an air introduction portion that introduces air into the combustion chamber, the air introduction portion included in the burner or in a vicinity of the burner;

a separation wall portion provided on a radially outer side of the liner with respect to the side wall portion, the separation wall portion forming an inner flow path communicating with the air introduction portion between the separation wall portion and the side wall portion;

an outer wall portion provided on a radially outer side of the liner with respect to the separation wall portion, the outer wall portion forming an outer flow path between the outer wall portion and the separation wall portion;

a plurality of communication holes formed in the separation wall portion in such a manner as to be separated from each other in a central axis direction of the liner, the communication holes allowing the inner flow path and the outer flow path to communicate with each other; and

a partition wall provided in the inner flow path, the partition wall partitioning the inner flow path in the central axis direction of the liner.

The combustion device may further include

a second air introduction portion formed at a position in the side wall portion farther from the burner in the central axis direction with respect to the partition wall, the second air introduction portion allowing the inner flow path and the combustion chamber to communicate with each other.

The combustion chamber may include

a primary zone located closer to the burner than the second air introduction portion is, and a secondary zone located farther from the burner in the central axis direction than the second air introduction portion is, and

the partition wall may be located radially outside the primary zone.

In order to solve the above problem, a gas turbine system of the present disclosure includes the combustion device described above.

### Effects

According to the present disclosure, an increase in harmful components in a combustion gas can be suppressed.

### BRIEF DESCRIPTION OF DRAWINGS

FIG. 1 is a schematic diagram illustrating the structure of a gas turbine system according to an embodiment of the present disclosure.

FIG. 2 is a diagram for explaining the operation of the combustion device according to the present embodiment.

FIG. 3 is a schematic diagram illustrating the structure of a gas turbine system according to a first modification.

FIG. 4 is a schematic diagram illustrating the structure of a gas turbine system according to a second modification.

### DESCRIPTION OF EMBODIMENTS

Embodiments of the present disclosure will be described below by referring to the accompanying drawings. Dimensions, materials, other specific numerical values, and the like illustrated in the embodiments are merely an example for facilitating understanding, and the present disclosure is not limited thereto unless otherwise specified. Note that, in the present specification and the drawings, components having substantially the same function and structure are denoted by the same symbol, and redundant explanations are omitted. Illustration of components not directly related to the present disclosure is omitted.

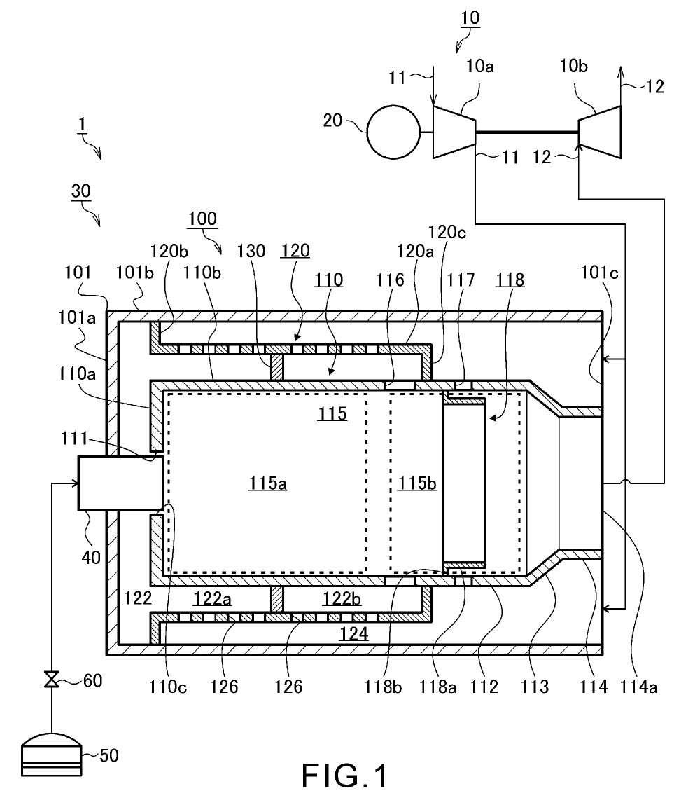

FIG. 1 is a schematic diagram illustrating the structure of a gas turbine system 1 according to the present embodiment. As illustrated in FIG. 1, the gas turbine system 1 includes a turbocharger 10, a generator 20, and a combustion device 30. The combustion device 30 includes a burner 40, an ammonia tank 50, a flow rate control valve 60, and a combustor 100.

The turbocharger 10 includes a compressor 10a and a turbine 10b. A vane wheel of the compressor 10a and a vane wheel of the turbine 10b rotate integrally. The vane wheel of the compressor 10a and the vane wheel of the turbine 10b are connected by a shaft.

The compressor 10a is provided in an intake flow path 11. The air supplied to the combustor 100 flows through the intake flow path 11. An intake port (not illustrated) through which the air is taken in from the outside is provided at an upstream end of the intake flow path 11. The air taken in from the intake port passes through the compressor 10a and is sent to the combustor 100. The compressor 10a compresses the air and discharges the air to the combustor 100.

The turbine 10b is provided in an exhaust flow path 12 connected with the combustor 100. A combustion gas discharged from the combustor 100 flows through the exhaust flow path 12. An exhaust port (not illustrated) through which the combustion gas is discharged to the outside is provided at a downstream end of the exhaust flow path 12. The combustion gas discharged from the combustor 100 passes through the turbine 10b and is sent to the exhaust port. The turbine 10b generates rotational power with the vane wheel of the turbine 10b rotated by the combustion gas.

The generator 20 is connected with the turbocharger 10. The generator 20 generates electric power using the rotational power generated by the turbocharger 10.

The burner 40 of the combustion device 30 injects ammonia as fuel into the combustor 100. The burner 40 has a substantially cylindrical shape. The burner 40 is attached to a casing 101, which will be described later, of the combustor 100. The front end of the burner 40 is located in the casing 101, and the rear end of the burner 40 is located outside the casing 101.

An injection valve (not illustrated) is provided at the front end of the burner 40. The ammonia tank 50 is connected to the rear end of the burner 40. Liquid ammonia is stored in the ammonia tank 50. The flow rate control valve 60 is provided in a flow path connecting the ammonia tank 50 and the burner 40. The ammonia stored in the ammonia tank 50 is supplied to the burner 40. The flow rate control valve 60 controls the flow rate of ammonia supplied from the ammonia tank 50 to the burner 40. Note that various devices (such as a shut-off valve, a check valve, or various sensors) not illustrated in FIG. 1 may be provided in the flow path connecting the ammonia tank 50 and the burner 40.

The combustor 100 includes the casing 101. The casing 101 is formed in a substantially bottomed cylindrical shape having a bottom face 101a and an outer wall portion 101b. An opening 101c connected to the intake flow path 11 is formed at an end of the outer wall portion 101b opposite to the bottom face 101a. The burner 40 is inserted through the bottom face 101a of the casing 101. The burner 40 is located substantially at the center of the bottom face 101a. In other words, the burner 40 is provided on the central axis of the casing 101.

A liner 110 is accommodated in the casing 101. The liner 110 is formed in a substantially bottomed cylindrical shape having a bottom portion 110a and a side wall portion 110b. The central axis of the liner 110 substantially coincides with the central axis of the casing 101. Therefore, the central axis of the liner 110 coincides with the central axis of the burner 40. Hereinafter, the central axis of the liner 110 may be referred to simply as the “central axis” or the “center”. In addition, a direction orthogonal to the central axis, namely, the radial direction of the liner 110 is simply referred to as the “radial direction”.

The outer diameter of the liner 110 is smaller than the inner diameter of the casing 101. As a result, an annular space is formed between the liner 110 and the casing 101. The bottom portion 110a of the liner 110 is separated from the bottom face 101a of the casing 101 in the central axis direction. Therefore, a clearance is formed between the bottom face 101a of the casing 101 and the bottom portion 110a of the liner 110.

A burner insertion hole 110c is formed in the bottom portion 110a of the liner 110. The front end of the burner 40 is inserted into the burner insertion hole 110c. The inner diameter of the burner insertion hole 110c is larger than the outer diameter of the burner 40. As a result, an annular air introduction portion 111 penetrating the bottom portion 110a in the central axis direction is formed in the bottom portion 110a of the liner 110. That is, the air introduction portion 111 is provided in the vicinity of the burner 40, more strictly, around the burner 40.

The liner 110 includes a large diameter portion 112, a shrinking diameter portion 113, and a small diameter portion 114. The large diameter portion 112 is located closer to the burner 40 than the shrinking diameter portion 113 and the small diameter portion 114 are. In addition, the small diameter portion 114 is located farther away from the burner 40 in the central axis direction than the large diameter portion 112 and the shrinking diameter portion 113 are. The inner diameter of the small diameter portion 114 is smaller than the inner diameter of the large diameter portion 112. The shrinking diameter portion 113 connects the large diameter portion 112 and the small diameter portion 114. The diameter of the shrinking diameter portion 113 decreases as it extends from the large diameter portion 112 toward the small diameter portion 114. That is, the shrinking diameter portion 113 has a tapered shape. Note that the shrinking diameter portion 113 may extend in the radial direction. An opening 114a to which the exhaust flow path 12 is connected is formed at an end of the small diameter portion 114 located on the opposite side to the shrinking diameter portion 113.

In this example, the inner diameter of the large diameter portion 112 is substantially constant regardless of the position in the central axis direction. Note that the inner diameter of the large diameter portion 112 may vary depending on the position in the central axis direction. For example, the large diameter portion 112 may have a tapered shape in which the diameter becomes larger or smaller as it is farther from the burner 40. Similarly, the inner diameter of the small diameter portion 114 may vary depending on the position in the central axis direction. For example, the small diameter portion 114 may have a tapered shape in which the diameter becomes larger or smaller as it is farther from the burner 40.

Furthermore, the entire liner 110 may have a tapered shape in which the diameter gradually decreases as it is farther from the burner 40. In this case, in the liner 110, a certain area on the burner 40 side serves as a large diameter portion 112, and a certain area on the side separated from the burner 40 serves as a small diameter portion 114. Furthermore, the liner 110 may have a constant diameter from the bottom portion 110a to the opening 114a. In any case, the shape of the liner 110 is not limited to the example of FIG. 1.

A combustion chamber 115 is formed on the inner side with respect to the side wall portion 110b, namely, inside the liner 110. The air introduction portion 111 communicates a space formed between the bottom portion 110a of the liner 110 and the bottom face 101a of the casing 101 with the combustion chamber 115. The air introduction portion 111 introduces air into the combustion chamber 115.

Here, the air introduction portion 111 for introducing air into the combustion chamber 115 is provided in the vicinity of the burner 40. That is, the air introduction portion 111 is provided separately from the burner 40. Note that the air introduction portion 111 may be provided in the burner 40. In this case, for example, it suffices that the air introduction portion 111 formed inside the burner 40 is opened to a space formed between the bottom portion 110a of the liner 110 and the bottom face 101a of the casing 101. Even in this case, the air introduced into the air introduction portion 111 is injected into the combustion chamber 115 via the burner 40. At this point, the air may be injected separately from the fuel, or may be mixed with the fuel in the burner 40 and injected as an air-fuel mixture.

The liner 110 includes a through-hole 116 penetrating the side wall portion 110b. The through-hole 116 penetrates the liner 110 in the radial direction. In this example, the liner 110 includes a plurality of through-holes 116. For example, the plurality of through-holes 116 are arranged at equal positions in the central axis direction of the liner 110 and are spaced apart from each other in the circumferential direction. Note that only one through-hole 116 may be formed in the liner 110. In a case where a plurality of through-holes 116 are formed, the positions of the plurality of through-holes 116 in the central axis direction may vary.

In this example, the through-holes 116 are formed in the large diameter portion 112. The through-holes 116 are formed at positions on a far side from the burner 40 with respect to the center position of the large diameter portion 112 in the central axis direction. Note that the through-holes 116 may be formed in the shrinking diameter portion 113 or the small diameter portion 114. The through-holes 116 function as a second air introduction portion that introduces air into the combustion chamber 115 from the outside of the liner 110. Hereinafter, the air introduced from the through-holes 116 into the combustion chamber 115 is referred to as dilution air.

Furthermore, as indicated by the box of the broken line in FIG. 1, the combustion chamber 115 includes a primary zone 115a located closer to the burner 40 than the through-holes 116 are and a secondary zone 115b provided at a position farther away from the burner 40 in the central axis direction than the primary zone 115a is. Here, the secondary zone 115b is defined as an area separated farther away from the burner 40 in the central axis direction than the through-holes 116 (ends thereof on the burner 40 side) are.

The liner 110 also includes a second through-hole 117 penetrating the side wall portion 110b. The second through-hole 117 penetrates the liner 110 in the radial direction. The second through-hole 117 is positioned closer to the opening 114a than the through-holes 116 are. In this example, the second through-hole 117 is smaller than the through-holes 116. Note that the size of the second through-hole 117 may be the same as that of the through-holes 116 or may be larger than that of the through-holes 116. In this example, the liner 110 includes a plurality of second through-holes 117. For example, the plurality of second through-holes 117 are arranged at equal positions in the central axis direction of the liner 110 and are spaced apart from each other in the circumferential direction. Note that only one second through-hole 117 may be formed in the liner 110. In a case where a plurality of second through-holes 117 are formed, the positions of the plurality of second through-holes 117 in the central axis direction may vary.

An annular guide member 118 is provided inside the liner 110. The guide member 118 includes a guide surface 118a extending in the circumferential direction and a flange portion 118b extending radially outward from the guide surface 118a. The guide member 118 is provided radially inside the second through-holes 117, and the second through-holes 117 face the guide surface 118a. A slight clearance is formed between the guide surface 118a and the second through-holes 117. The flange portion 118b is provided at an end of the guide surface 118a on the burner 40 side. The radially outer side of the flange portion 118b is connected to the inner peripheral surface of the side wall portion 110b. As a result, the space formed between the second through-holes 117 and the guide surface 118a is sealed on the burner 40 side and opened on the opening 114a side.

The combustor 100 also includes a flow path forming member 120. The flow path forming member 120 is provided between the side wall portion 110b and the outer wall portion 101b. The flow path forming member 120 includes a separation wall portion 120a located radially outside the side wall portion 110b and radially inside the outer wall portion 101b. The separation wall portion 120a is separated from both the side wall portion 110b and the outer wall portion 101b in the radial direction. The separation wall portion 120a has an annular shape substantially parallel to the central axis direction, and faces the outer wall portion 101b and the side wall portion 110b substantially parallel to each other. Note that the separation wall portion 120a may have a tapered shape inclined with respect to the central axis. Alternatively, the diameter of the separation wall portion 120a may vary depending on the position in the central axis direction.

The flow path forming member 120 includes a first end 120b and a second end 120c. The first end 120b is provided at the end of the separation wall portion 120a on the burner 40 side, and extends radially outward from the separation wall portion 120a. The radially outer side of the first end 120b is connected to the outer wall portion 101b. In addition, the second end 120c is provided at an end of the separation wall portion 120a on the opening 114a side, and extends radially inward from the separation wall portion 120a. The radially inner side of the second end 120c is connected to the side wall portion 110b.

The space formed between the outer wall portion 101b and the side wall portion 110b is partitioned in the radial direction by the separation wall portion 120a. Specifically, the separation wall portion 120a is provided on the radially outer side of the liner 110 with respect to the side wall portion 110b, and forms an inner flow path 122 together with the side wall portion 110b. In addition, the outer wall portion 101b is provided on the radially outer side of the liner 110 with respect to the separation wall portion 120a, and forms an outer flow path 124 together with the separation wall portion 120a. That is, the space formed between the outer wall portion 101b and the side wall portion 110b is partitioned by the separation wall portion 120a into the inner flow path 122 located on the radially inner side with respect to the separation wall portion 120a and the outer flow path 124 located on the radially outer side with respect to the separation wall portion 120a.

The inner flow path 122 communicates with the air introduction portion 111. The outer flow path 124 is connected to the intake flow path 11 at the opening 101c. An end of the outer flow path 124 on the burner 40 side is sealed by the first end 120b. An end of the inner flow path 122 on the opening 101c side is sealed by the second end 120c.

A plurality of communication holes 126 are formed in the separation wall portion 120a. The plurality of communication holes 126 are formed in the separation wall portion 120a in such a manner as to be separated from each other in the central axis direction of the liner 110, and allow the inner flow path 122 and the outer flow path 124 to communicate with each other. In other words, the inner flow path 122 and the outer flow path 124 are connected via the plurality of communication holes 126. The plurality of the communication holes 126 are formed also in such a manner as to be separated from each other in the circumferential direction. Here, the communication holes 126 are smaller than the through-holes 116. In this example, the plurality of communication holes 126 all have the same size; however, a plurality of communication holes 126 having different sizes and shapes may be formed. The size, the shape, and the number of communication holes 126 are merely examples, and are not particularly limited.

The inner flow path 122 is provided with a partition wall 130 that partitions the inner flow path 122 in the central axis direction of the liner 110. The partition wall 130 is formed in an annular shape, an end on the inner diameter side is connected to the side wall portion 110b, and an end on the outer diameter side is connected to the separation wall portion 120a. The partition wall 130 partitions the inner flow path 122 into a first inner flow path 122a located on the burner 40 side and a second inner flow path 122b located on the opening 114a side. The first inner flow path 122a communicates with the air introduction portion 111. The second inner flow path 122b communicates with the through-holes 116. Therefore, the through-holes 116 allow the second inner flow path 122b and the combustion chamber 115 to communicate with each other. The through-holes 116 are formed at positions farther from the burner 40 with respect to the partition wall 130 in the central axis direction. Furthermore, since the primary zone 115a is provided closer to the burner 40 than the through-holes 116 are, the partition wall 130 is located radially outside the primary zone 115a.

The communication holes 126 are provided on both of one side and the other side in the central axis direction with the partition wall 130 as a boundary. In FIG. 1, the number of communication holes 126 formed on the burner 40 side with respect to the partition wall 130 is equal to the number of communication holes 126 formed on the opening 114a side with respect to the partition wall 130. Note that the number of the communication holes 126 formed on the burner 40 side and the opening 114a side with respect to the partition wall 130 may be different.

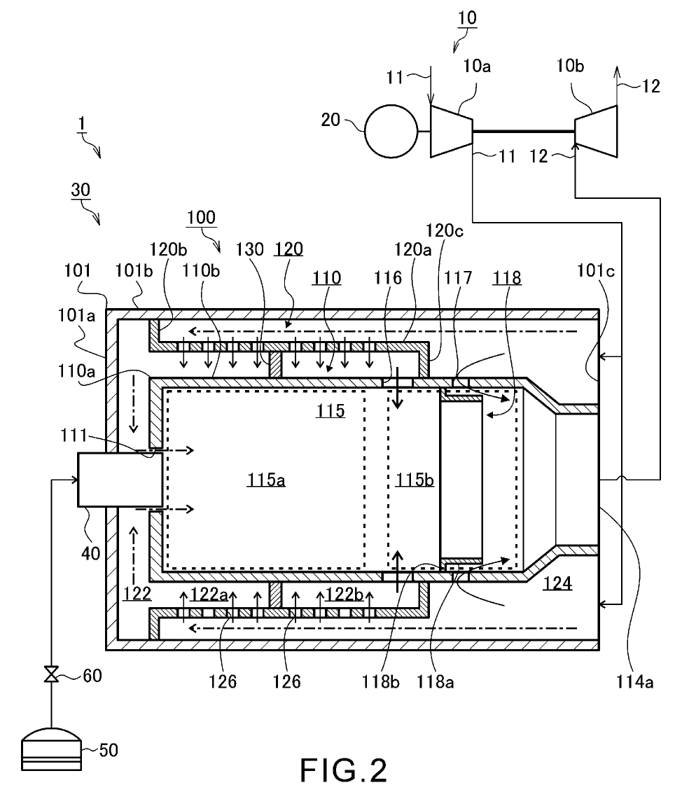

FIG. 2 is a diagram for explaining the operation of the combustion device 30 according to the present embodiment. As illustrated in FIG. 2, an intake flow path 11 is connected to an outer flow path 124, and the air compressed by a compressor 10a is supplied to the outer flow path 124. The air sent to the outer flow path 124 is guided to a burner 40 side along a separation wall portion 120a as indicated by an arrow of a one-dot chain line in the drawing. Then, the air flowing through the outer flow path 124 flows into a first inner flow path 122a and a second inner flow path 122b from communication holes 126.

The air flowing into the first inner flow path 122a is injected from an air introduction portion 111 into a combustion chamber 115, particularly a primary zone 115a. In addition, ammonia whose flow rate has been adjusted by the flow rate control valve 60 is supplied to the burner 40 as fuel. The fuel is injected into the combustion chamber 115 from an injection valve provided at the front end of the burner 40. At this point, the fuel may be injected from the burner 40 in the central axis direction. Alternatively, the fuel may be injected in a direction expanding in the radial direction as it is farther from the burner 40.

Note that the injection valve provided in the burner 40 is a pressure injection valve or an air flow injection valve. A pressure injection valve is a type of valve that atomizes liquid using a pressure difference between the inside and the outside of the pressure injection valve. The air flow injection valve is a type of valve that generates a film of liquid to be injected and atomizes the liquid using a shearing force between the film and air. Note that the configuration of the injection valve is not particularly limited. Note that, although liquid ammonia is used as fuel in this example, gaseous ammonia may be used. Note that other fuels such as natural gas or hydrogen may be used as the fuel supplied to the combustion chamber 115 in addition to ammonia.

Fuel injected from the burner 40 and air injected from the air introduction portion 111 are mixed to generate an air-fuel mixture. That is, the air-fuel mixture is supplied to the combustion chamber 115. A combustor 100 is provided with an ignition device (not illustrated), and a combustion behavior occurs in the combustion chamber 115 by ignition by the ignition device. The combustion gas generated by the combustion is discharged to an exhaust flow path 12 connected to an opening 114a.

In this example, in the primary zone 115a, the flow rates of air and fuel are adjusted such that the air-fuel mixture is rich in fuel with an equivalence ratio of the air-fuel mixture of about 1.0 to 1.5. Therefore, the combustion in the primary zone 115a is rich combustion. Meanwhile, through-holes 116 are formed in the liner 110, and dilution air is supplied from the second inner flow path 122b to the combustion chamber 115 via the through-holes 116. In the secondary zone 115b, the dilution air is mixed with the air-fuel mixture, whereby the combustion in the secondary zone 115b is lean combustion. As described above, in the present embodiment, rich combustion is performed in the primary zone 115a, and lean combustion is performed in the secondary zone 115b.

The air having flowed into the first inner flow path 122a cools a side wall portion 110b of the liner 110, and then is injected from the air introduction portion 111 into the combustion chamber 115. Meanwhile, the air having flowed into the second inner flow path 122b cools the side wall portion 110b of the liner 110, and then is introduced into the combustion chamber 115 from the through-holes 116 as dilution air. In other words, the side wall portion 110b on the burner 40 side with respect to a partition wall 130 is cooled by the air supplied to the burner 40. On the other hand, the side wall portion 110b on the opening 114a side with respect to the partition wall 130 is cooled by the air introduced from the through-holes 116 into the combustion chamber 115.

At this point, when the flow rate of the air supplied to the air introduction portion 111 decreases, there is a possibility that emissions of NOx, unburned NH₃, N₂O, and the like generated from ammonia increase. If the partition wall 130 is not provided, the area of the inner flow path 122 through which the air supplied to the air introduction portion 111 passes is widened. In this case, it is difficult to design to supply air having an appropriate flow rate and flow velocity to the air introduction portion 111. Therefore, the flow rate of the air supplied to the air introduction portion 111 may decrease, and the emission may increase. According to the present embodiment, the partition wall 130 limits the circulation area of the inner flow path 122 through which the air supplied to the air introduction portion 111 circulates. As a result, air having an appropriate flow rate and flow velocity can be supplied to the air introduction portion 111.

The partition wall 130 also limits the area of the second inner flow path 122b. That is, the cooling area by the dilution air supplied from the through-holes 116 to the combustion chamber 115 is limited. Therefore, the cooling effect of the liner 110 by the dilution air is enhanced. In particular, in the impingement cooling in which the liner 110 is cooled by causing the air to flow along the side wall portion 110b, when the amount of flow along the side wall portion 110b increases, the cooling effect decreases. In the present embodiment, the area of the side wall portion 110b facing each of the first inner flow path 122a and the second inner flow path 122b is reduced, and thus the amount of flow along the side wall portion 110b is suppressed. This suppresses a decrease in the cooling effect.

In the inner flow path 122, the partition wall 130 is located most upstream in the air flow direction. That is, the partition wall 130 is located most upstream in each of the first inner flow path 122a and the second inner flow path 122b. Therefore, the partition wall 130 is in contact with air having the highest cooling capacity in the inner flow path 122. In a case where flame-retardant fuel such as ammonia is used, flame is likely to be located downstream of the outlet of the burner 40, and the vicinity of the center in the central-axis direction in the primary zone 115a tends to have a high temperature. With the partition wall 130 in contact with the air having the highest cooling capacity disposed at a position where the temperature is likely to be high, the cooling efficiency of the liner 110 is improved.

The secondary zone 115b is provided with second through-holes 117. The air having flowed into the combustion chamber 115 from the second through-holes 117 flows along the side wall portion 110b of the liner 110. As a result, an area surrounding the secondary zone 115b in the side wall portion 110b of the liner 110 is cooled.

Hereinafter, modifications of the above-described embodiment will be described. Note that, in the following, in each modification, a structure different from that of the above embodiment will be described, and the same structure as that of the above embodiment will be denoted by the same reference numerals as those described above, and a detailed description thereof will be omitted. Therefore, each modification described below has the same structure as that of the above embodiment unless otherwise specified.

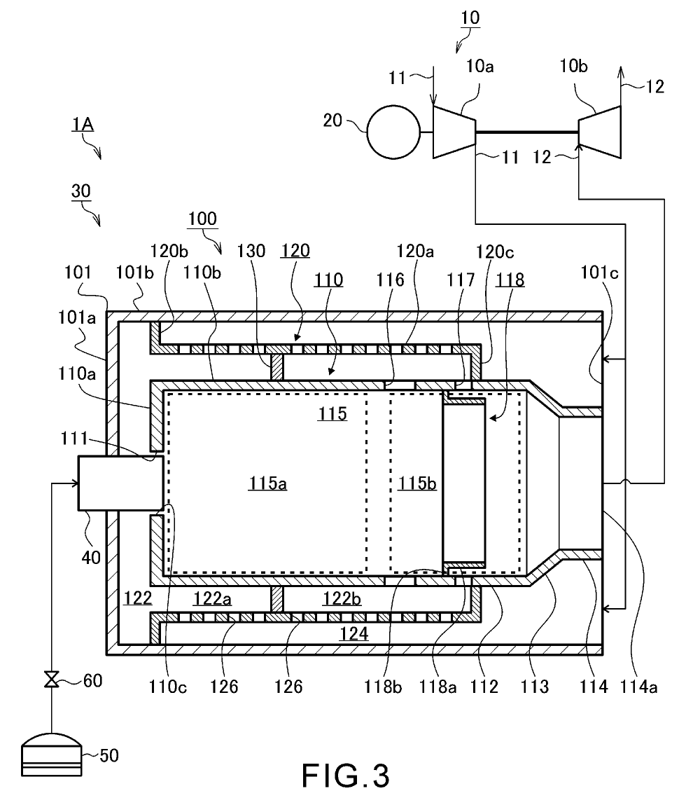

FIG. 3 is a schematic diagram illustrating the structure of a gas turbine system 1A according to a first modification. The first modification is different from the above embodiment in that second through-holes 117 open in the second inner flow path 122b. In the first modification, the length of a separation wall portion 120a in the central axis direction is different from that of the above-described embodiment, and other structures are the same as those of the embodiment. In the first modification, as compared with the embodiment, the separation wall portion 120a is longer in the central axis direction, and a second end 120c is provided on the opening 114a side with respect to the second through-hole 117. As a result, through-holes 116 and second through-holes 117 are included in a second inner flow path 122b. Therefore, a part of the air having flowed into the second inner flow path 122b from an outer flow path 124 via communication holes 126 flows into the combustion chamber 115 from the through-holes 116, and the other part of the air flows into a combustion chamber 115 from the second through-holes 117. The first modification also achieves similar actions and effects to those of the above embodiment.

In the above embodiment and the first modification, for example, one or more second through-holes 117 and one or more guide members 118 may be further provided on the burner 40 side with respect to the through-holes 116. In this case, the second through-holes 117 and the guide members 118 may be provided on the burner 40 side with respect to the partition wall 130, or may be provided on the opening 114a side with respect to the partition wall 130. That is, the cooling of the side wall portion 110b by the air flowing into the combustion chamber 115 from the second through-holes 117 may be performed in the primary zone 115a.

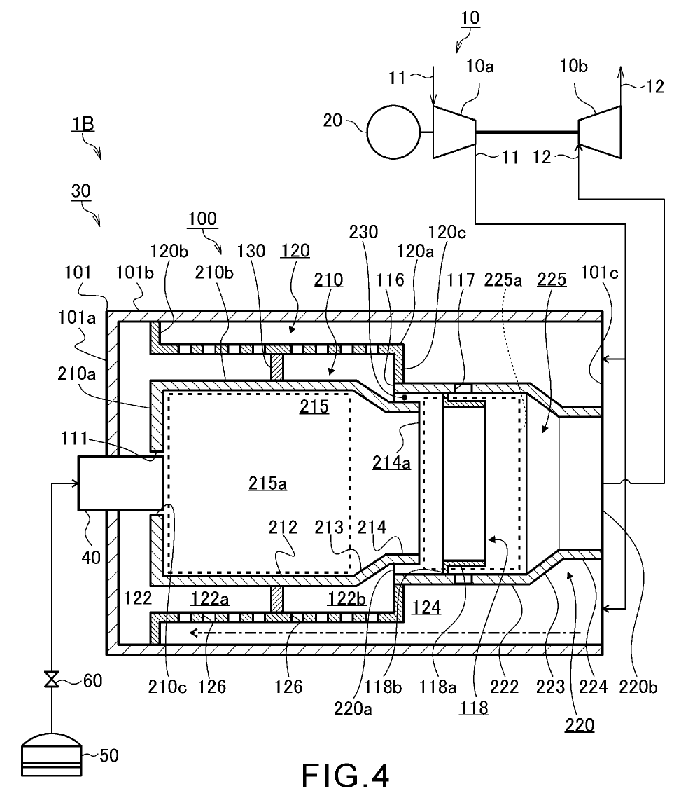

FIG. 4 is a schematic diagram illustrating the structure of a gas turbine system 1B according to a second modification. A combustor 100 according to the second modification includes a first liner 210 and a second liner 220 instead of the liner 110 of the above embodiment. The first liner 210 and the second liner 220 are housed inside a casing 101. The first liner 210 and the second liner 220 have a substantially cylindrical shape. The first liner 210 and the second liner 220 are configured separately from each other, namely, by separate members.

In the casing 101, the first liner 210 is provided closer to the burner 40 than the second liner 220 is. The outer diameters of the first liner 210 and the second liner 220 are smaller than the inner diameter of the casing 101. As a result, an outer flow path 124 is formed between the first liner 210 and the second liner 220 and the casing 101.

The central axes of the first liner 210 and the second liner 220 substantially coincide with the central axes of the casing 101 and a burner 40. The first liner 210 is formed in a substantially bottomed cylindrical shape having a bottom portion 210a and a side wall portion 210b. A burner insertion hole 210c is formed in the bottom portion 210a of the first liner 210. The front end of the burner 40 is inserted into the burner insertion hole 210c. The inner diameter of the burner insertion hole 210c is larger than the outer diameter of the burner 40. As a result, an annular air introduction portion 111 penetrating the bottom portion 210a in the central axis direction is formed in the bottom portion 210a of the first liner 210.

The first liner 210 includes a large diameter portion 212, a shrinking diameter portion 213, and a small diameter portion 214. The large diameter portion 212 is located closer to the burner 40 than the shrinking diameter portion 213 and the small diameter portion 214 are. In addition, the small diameter portion 214 is located farther away from the burner 40 in the central axis direction than the large diameter portion 212 and the shrinking diameter portion 213 are. The inner diameter of the small diameter portion 214 is smaller than the inner diameter of the large diameter portion 212. The shrinking diameter portion 213 connects the large diameter portion 212 and the small diameter portion 214. The diameter of the shrinking diameter portion 213 decreases as it extends from the large diameter portion 212 toward the small diameter portion 214. That is, the shrinking diameter portion 213 has a tapered shape. Note that the shrinking diameter portion 213 may extend in the radial direction. An opening 214a is formed at an end of the small diameter portion 214 located on the opposite side of the shrinking diameter portion 213.

In the second modification, the inner diameter of the large diameter portion 212 of the first liner 210 is substantially constant regardless of the position in the central axis direction. Note that the inner diameter of the large diameter portion 212 may vary depending on the position in the central axis direction. For example, the large diameter portion 212 may have a tapered shape in which the diameter becomes larger or smaller as it is farther from the burner 40. Similarly, the inner diameter of the small diameter portion 214 may vary depending on the position in the central axis direction. For example, the small diameter portion 214 may have a tapered shape in which the diameter becomes larger or smaller as it is farther from the burner 40.

Furthermore, the entire first liner 210 may have a tapered shape in which the diameter gradually decreases as it is farther from the burner 40. Furthermore, the first liner 210 may have a constant diameter from the bottom portion 210a to the opening 214a. In any case, the shape of the first liner 210 is not limited to the example of FIG. 4.

A first combustion chamber 215 is formed inside the large diameter portion 212, the shrinking diameter portion 213, and the small diameter portion 214. That is, the first combustion chamber 215 is formed inside the first liner 210. Furthermore, a primary zone 215a indicated by a box of a broken line in the drawing is formed inside the large diameter portion 212. A flow path forming member 120 is provided radially outside the first liner 210. Also in the second modification, the inner flow path 122 and the outer flow path 124 are provided radially outside the first liner 210. Also in the second modification, a partition wall 130 is provided between the side wall portion 210b of the first liner 210 and a separation wall portion 120a. Therefore, the inner flow path 122 facing the side wall portion 210b is partitioned into a first inner flow path 122a and a second inner flow path 122b by the partition wall 130.

The second liner 220 is formed of a substantially cylindrical member in which openings 220a and 220b are formed at both ends. The second liner 220 includes a second large diameter portion 222, a second shrinking diameter portion 223, and a second small diameter portion 224. The second large diameter portion 222 is located closer to the burner 40 than the second shrinking diameter portion 223 and the second small diameter portion 224 are. In addition, the second small diameter portion 224 is located farther away from the burner 40 in the central axis direction than the second large diameter portion 222 and the second shrinking diameter portion 223 are. The inner diameter of the second small diameter portion 224 is smaller than the inner diameter of the second large diameter portion 222. The second shrinking diameter portion 223 connects the second large diameter portion 222 and the second small diameter portion 224. The diameter of the second shrinking diameter portion 223 decreases as it extends from the second large diameter portion 222 toward the second small diameter portion 224. That is, the second shrinking diameter portion 223 has a tapered shape. Note that the second shrinking diameter portion 223 may extend in the radial direction. An opening 220a is formed at the end of the second large diameter portion 222 on the burner 40 side. In addition, an opening 220b connected to an exhaust flow path 12 is formed at an end of the second small diameter portion 224 located on a side opposite to the second shrinking diameter portion 223.

In the second modification, the inner diameter of the second large diameter portion 222 of the second liner 220 is substantially constant regardless of the position in the central axis direction. Note that the inner diameter of the second large diameter portion 222 may vary depending on the position in the central axis direction. For example, the second large diameter portion 222 may have a tapered shape in which the diameter becomes larger or smaller as it is farther from the burner 40. Similarly, the inner diameter of the second small diameter portion 224 may vary depending on the position in the central axis direction. For example, the second small diameter portion 224 may have a tapered shape in which the diameter becomes larger or smaller as it is farther from the burner 40.

Furthermore, the entire second liner 220 may have a tapered shape in which the diameter gradually decreases as it is farther from the burner 40. Furthermore, the second liner 220 may have a constant diameter from the opening 220a to the opening 220b. In any case, the shape of the second liner 220 is not limited to the example of FIG. 4.

A second combustion chamber 225 is formed inside the second large diameter portion 222, the second shrinking diameter portion 223, and the second small diameter portion 224. That is, the second combustion chamber 225 is formed inside the second liner 220. A secondary zone 225a indicated by a box of a broken line in the drawing is formed inside the second large diameter portion 222. Note that second through-holes 117 are formed in the second large diameter portion 222 and that a guide member 118 is provided in the secondary zone 225a.

The small diameter portion 214 of the first liner 210 is inserted into the opening 220a of the second liner 220. Therefore, the inner diameter of the second large diameter portion 222 of the second liner 220 is larger than the outer diameter of the small diameter portion 214 of the first liner 210. An end of the small diameter portion 214 of the first liner 210 where an opening 214a is formed is located in the second liner 220. The outer peripheral surface of the small diameter portion 214 of the first liner 210 faces the inner peripheral surface of the second large diameter portion 222 of the second liner 220 in the radial direction. In this case, the outer peripheral surface of the small diameter portion 214 and the inner peripheral surface of the second large diameter portion 222 are separated from each other. In other words, the second liner 220 overlaps the first liner 210.

Via the opening 214a, the first combustion chamber 215 in the first liner 210 communicates with the second combustion chamber 225 in the second liner 220. That is, the first liner 210 and the second liner 220 constitute one liner, and the first combustion chamber 215 and the second combustion chamber 225 constitute one combustion chamber.

In addition, an annular flow path 230 is formed between the inner peripheral surface of the second large diameter portion 222 of the second liner 220 and the outer peripheral surface of the small diameter portion 214 of the first liner 210. The front end of the second large diameter portion 222, namely, the opening 220a is separated from the shrinking diameter portion 213 of the first liner 210 in the central axis direction. As a result, the flow path 230 communicates with the second inner flow path 122b. That is, the flow path 230 functions as a second air introduction portion that introduces dilution air from the second inner flow path 122b into the second combustion chamber 225. Therefore, the second modification also achieves similar actions and effects to those of the above embodiment.

In the second modification, the first liner 210 and the second liner 220 are configured separately, but the first liner 210 and the second liner 220 may be integrally molded. Alternatively, the first liner 210 and the second liner 220 may be configured separately, and may be fixed to each other by welding or a fixing member such as a bolt. In this case, it is easy to attach and detach the first liner 210 and the second liner 220 to and from the casing 101. Note that the first liner 210 and the second liner 220 may be configured separately, and may be attached separately to the casing 101. In this case, the thermal deformation of the first liner 210 and the second liner 220 is absorbed by the flow path 230, whereby durability is improved.

Note that the first modification may be applied to the second modification. That is, in FIG. 4, a second end 120c of the flow path forming member 120 may be positioned on the opening 220b side with respect to the second through-hole 117. In the second modification, the first liner 210 and the second liner 220 are configured separately. Note that the first liner 210 and the second liner 220 may be integrally molded.

Although the embodiments of the present disclosure have been described with reference to the accompanying drawings, it is naturally understood that the present disclosure is not limited to the above embodiments. It is clear that those skilled in the art can conceive various modifications or variations within the scope described in the claims, and it is understood that they are naturally also within the technical scope of the present disclosure.

The examples in which the rotational power generated by the turbocharger 10 is used as energy for driving the generator 20 in the gas turbine systems 1, 1A, and 1B have been described above. However, in the gas turbine system 1, the rotational power generated by the turbocharger 10 may be used for other purposes. Examples of other applications include an application for driving a traveling body such as a ship.

The examples in which the combustion device 30 is used in the gas turbine systems 1, 1A, and 1B have been described above. Note that the combustion device 30 may be used in a device other than the gas turbine systems 1, 1A, and 1B. Examples of the device other than the gas turbine systems 1, 1A, and 1B include an industrial furnace for changing the shape or the property of a material by combustion in a combustor.

1. A combustion device, comprising: a liner in which a combustion chamber is formed inside a side wall portion; a burner that injects fuel into the combustion chamber, the burner provided to the liner; an air introduction portion that introduces air into the combustion chamber, the air introduction portion included in the burner or in a vicinity of the burner; a separation wall portion provided on a radially outer side of the liner with respect to the side wall portion, the separation wall portion forming an inner flow path communicating with the air introduction portion between the separation wall portion and the side wall portion; an outer wall portion provided on a radially outer side of the liner with respect to the separation wall portion, the outer wall portion forming an outer flow path between the outer wall portion and the separation wall portion; a plurality of communication holes formed in the separation wall portion in such a manner as to be separated from each other in a central axis direction of the liner, the communication holes allowing the inner flow path and the outer flow path to communicate with each other; and a partition wall provided in the inner flow path, the partition wall partitioning the inner flow path in the central axis direction of the liner.

2. The combustion device according to claim 1, further comprising: a second air introduction portion formed at a position in the side wall portion farther from the burner in the central axis direction with respect to the partition wall, the second air introduction portion allowing the inner flow path and the combustion chamber to communicate with each other.

4. A gas turbine system comprising: the combustion device according to claim 1.

3. The combustion device according to claim 2, wherein the combustion chamber includes a primary zone located closer to the burner than the second air introduction portion is, and a secondary zone located farther from the burner in the central axis direction than the second air introduction portion is, and
the partition wall is located on a radially outer side of the primary zone.
